(19) United States
(12) Patent Application Publication
(10) Pub. No.: US 2019/0116819 A1
(43) Pub. Date: Apr. 25, 2019

(54) Smoking Apparatus

(71) Applicant: ANGELO PO GRANDI CUCINE S.p.A., Carpi (IT)

(72) Inventor: Gerardo Capriglione, Carpi (IT)

(21) Appl. No.: 16/164,987

(22) Filed: Oct. 19, 2018

(30) Foreign Application Priority Data
Oct. 19, 2017 (IT) 102017000118716

(51) Int. Cl. A23B 4/052; A23B 4/056

(52) U.S. Cl. CPC A23B 4/0523; A23V 2002/00; A23B 4/056

(57) ABSTRACT

A smoking apparatus includes a body inside which a chamber is defined into which a sliding element is insertable in which elements of combustible material can be arranged, a heating arrangement arranged in the sliding element to heat the elements of combustible material and cause flameless combustion thereof with generation of smoke. In the sliding element a tubular element is arranged that is provided with a plurality of second suction openings communicating with the inside of the sliding element, the tubular element being connected, at a first end, to a first wall of the sliding element, whereas a second end thereof is inserted into an outlet conduit.

### TECHNICAL FIELD

The invention relates to a smoking apparatus intended to being associated to a cooking apparatus, for example an oven, to smoke foods cooking in the cooking apparatus. Cooking and smoking apparatuses are known comprising a cooking chamber for containing on a plurality of planes foods to be cooked and smoked.

### BACKGROUND

Such apparatuses further comprise a combustion and smoking chamber in which elements of combustible material, such as pieces of wood or coal, are burnt to produce a smoking smoke to smoke the aforesaid foods.

The combustion and smoking chamber communicates by one or more openings with an external environment from which the air is sucked to be used to burn the elements of combustible material.

The combustion and smoking chamber further comprises a connecting conduit by which the combustion and smoking chamber is connected to the cooking chamber.

From IT 01378629 a cooking and smoking apparatus is known for cooking and smoking foods that comprises a cooking chamber for containing said foods, a heating arrangement positioned in the cooking chamber, to heat said foods, a smoking chamber in which elements of combustible material such as pieces of wood or coal are burnt, to produce a smoking smoke to smoke said foods, said smoking chamber being provided with an opening through which the air taken from the external environment can be introduced into the smoking chamber, a further heating arrangement arranged in said smoking chamber to cause the combustion of said elements of combustible material and produce the smoking smoke, a connecting conduit to connect the smoking chamber to the cooking chamber and a fan, arranged in the cooking chamber and communicating with the connecting conduit, by which a vacuum can be created in the connecting conduit and in the smoking chamber, owing to which air sucked from the external environment through the opening of the smoking chamber and the smoke produced in the smoking chamber are conveyed to the connecting conduit to be sent to the cooking chamber.

The apparatus disclosed in IT 01378629 enables cooking and smoking cycles to be run, or just cooking cycles, without smoking. In order to run a cooking and smoking cycle, both the heating arrangement of the cooking chamber and the heating arrangement of the smoking chamber are activated. In order to run only a cooking cycle, only the heating arrangement of the cooking chamber is activated.

The apparatus disclosed in IT 01378629 has some drawbacks. First of all, when the smoking chamber is activated fragments of the elements of combustible material may be sucked together with the smoke into the cooking chamber, thus contaminating the foods being cooked. Further, the smoking chamber is integrated into the apparatus and is not separable from the cooking chamber, which means that if a fault occurs in the heating arrangement of the smoking chamber, or if elements of combustible material have to be provided, or the smoking chamber has to be cleaned, the entire apparatus becomes unusable for the time required to repair the fault or required for smoking chamber supply and maintenance operations.

### SUMMARY

The present invention proposes to provide a smoking apparatus that can be associated to a cooking apparatus, which does not involve the risk of introducing fragments of combustible material into the cooking apparatus, which improves the efficiency of combustion of the elements of combustible material in the smoking chamber and does not entail cooking apparatus downtime in the event of faults in the smoking chamber or smoking chamber supply and maintenance operations.

According to the present invention, a smoking apparatus is provided that comprises a smoking chamber in which elements of combustible material can be arranged, a heating arrangement to heat said elements of combustible material and cause flameless combustion thereof with generation of smoke, at least one suction opening through which air from the external environment can be sucked into said smoking chamber, wherein in said smoking chamber a tubular element is arranged that is provided with a plurality of openings communicating with said smoking chamber and connected to an end with an outlet conduit that can be removably connected to a combustion chamber of a cooking apparatus, said openings being distributed in a substantially uniform manner in a direction parallel to a longitudinal axis of the tubular element.

The possibility of removably connecting the outlet conduit of the smoking chamber to the cooking chamber of a cooking apparatus enables the cooking apparatus to be able to be used even when the smoking apparatus is not usable for any reason. In this case it is sufficient to disconnect the smoking apparatus from the cooking apparatus.

Further, the substantially uniform distribution of the openings on the tubular element enables the circulation of the air in the smoking chamber to be optimized, such that it is distributed almost uniformly in the mass of the elements of combustible material, enabling substantially uniform combustion to be obtained in all the zones of the smoking chamber, thus optimizing the production of smoke.

In one preferred embodiment of the present invention, said tubular element is surrounded by a protection element. The protection element prevents incandescent fragments of the combustible material being able to be sucked inside the tubular element through the openings thereof and reach the cooking chamber, contaminating the foods contained therein during the cooking step.

In a further preferred embodiment of the present invention, the heating arrangement is provided with a screening element, arranged to prevent the elements of combustible material being able to come into contact with the heating arrangement.

Preventing the elements of combustible material coming into contact with the heating arrangement prevents the elements of combustible material burning with rapid combustion with a fierce flame, which would lead to poor smoke production, drastically reducing the efficiency of the smoking apparatus.

In a still further preferred embodiment of the present invention, the outlet conduit of the smoking chamber is made so as to be able to rotate around a rotation axis that coincides substantially with a longitudinal axis of the tubular element. The possibility of rotating the outlet conduit makes positioning of the smoking apparatus more flexible with respect to the cooking apparatus and makes connecting the outlet conduit to the cooking apparatus easier.

### BRIEF DESCRIPTION OF THE DRAWINGS

Further features and advantages of the present invention are shown in the description that follows that illustrates merely by way of example an embodiment of the present invention, with reference to the attached drawings, in which:

FIGS. 1 and 2 are prospective views of a smoking apparatus according to the invention;

FIG. 3 is a top view of the smoking apparatus according to the invention in which the inside of the apparatus is shown;

FIG. 4 is a view like the one in FIG. 3, in which the heating arrangement and the tubular element have been shown;

FIG. 5 is the section V-V of FIG. 3;

FIG. 6 is a raised side view of the smoking apparatus according to the invention;

FIG. 7 illustrates schematically an example of a connection of the smoking apparatus according to the invention with a cooking apparatus;

FIG. 8 is the section VIII-VIII of FIG. 4;

FIG. 9 is an enlarged detail P of FIG. 4, but relating to a variant of the apparatus according to the invention;

FIG. 10 is a perspective view of a further variant of the smoking apparatus according to the invention;

FIG. 11 is a raised view of the apparatus of FIG. 10;

FIG. 12 is an enlarged detail of the apparatus of FIG. 10;

FIG. 13 is the section XIII-XIII of FIG. 11.

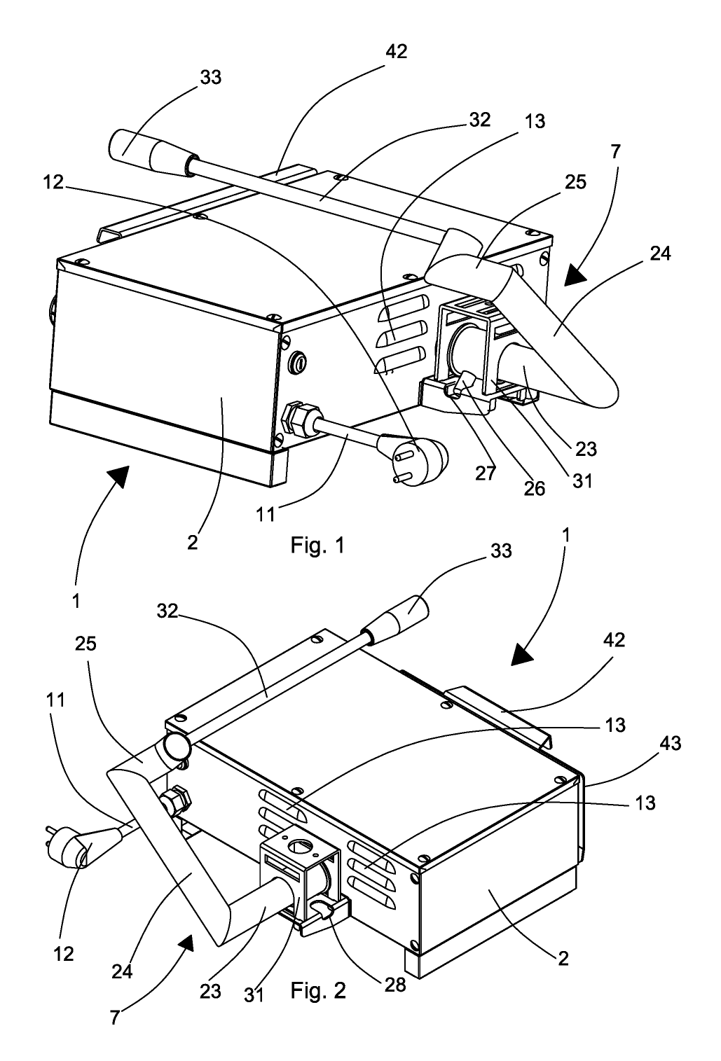

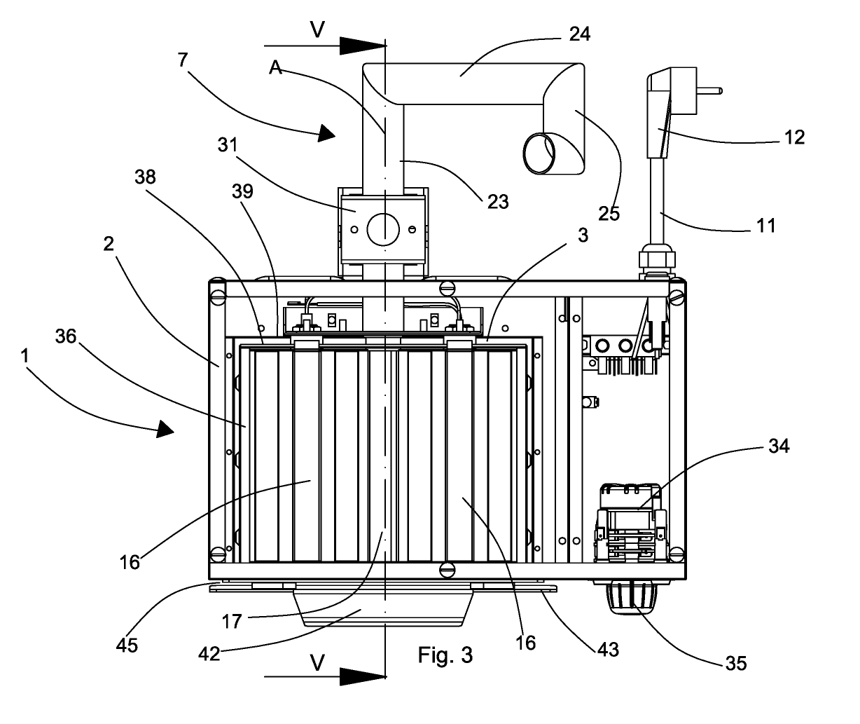

### DETAILED DESCRIPTION

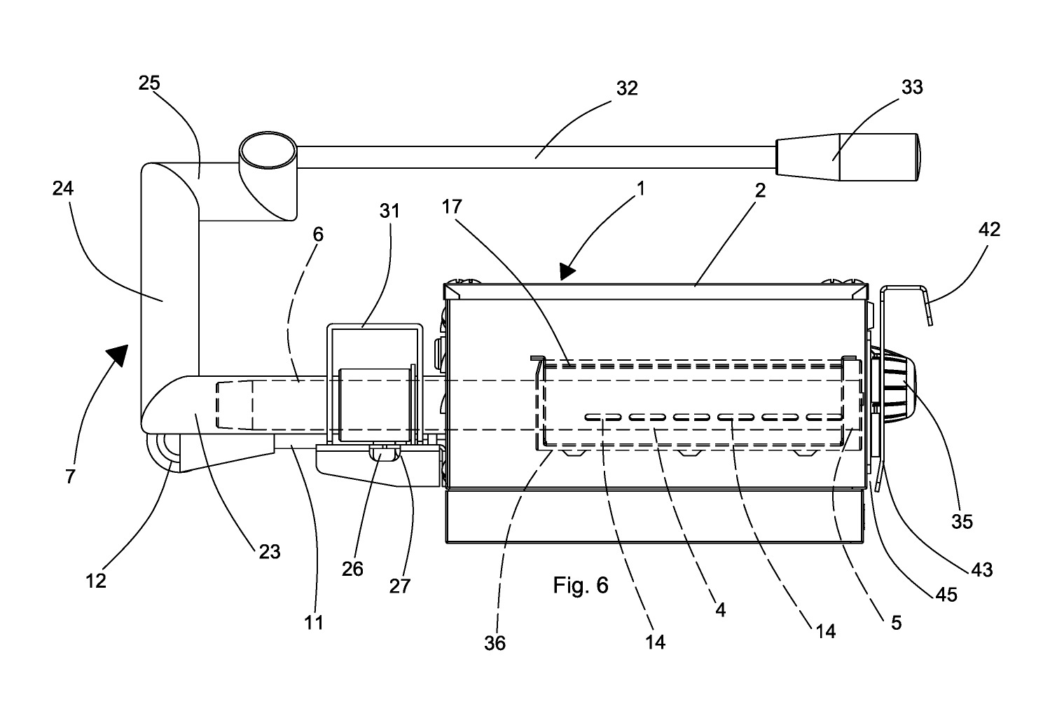

With reference to the figures, a smoking apparatus 1 according to the invention comprises a body 2, inside which a chamber 3 is defined, in which a drawer-shaped sliding element 36 is insertable in which elements of combustible material 29 (FIG. 6) to be burnt to produce smoking smoke, for example small pieces of wood or coal, can be placed. The drawer-shaped sliding element 36 will be referred to below as the drawer 36 for short.

The drawer 36 is provided with a handle 42, fixed to a plate 43 connected to a first wall 37 of the drawer 36. The handle 42 can be made as single body with the plate 43.

Between the plate 43 and the first wall 37 a space 45 is defined.

The body 2 is provided with at least one first ventilation opening 13, advantageously a plurality of first ventilation openings 13, for example in the form of a slit.

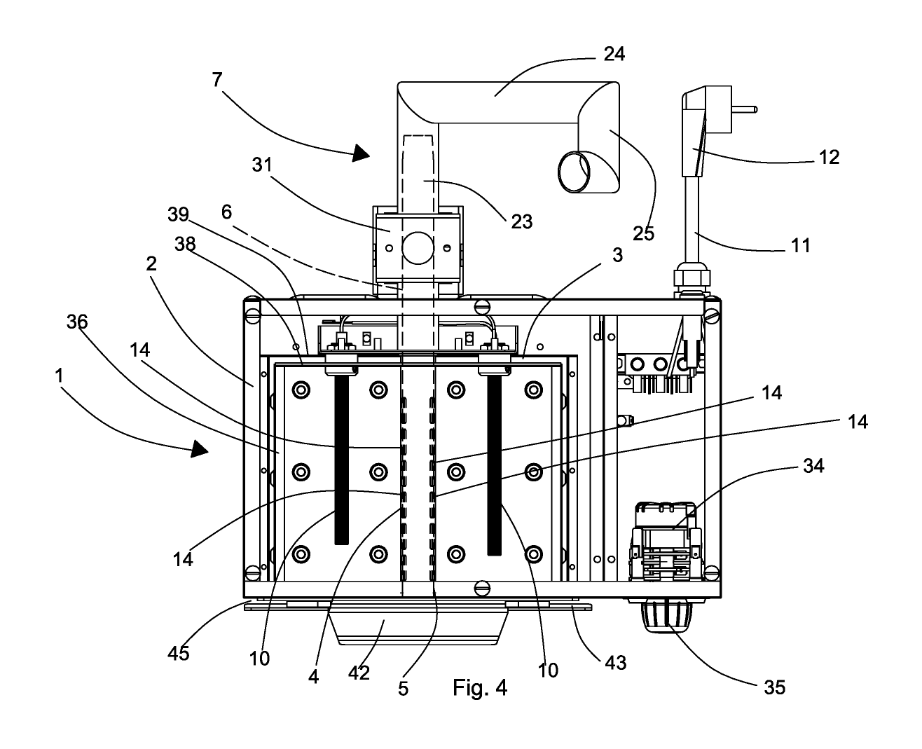

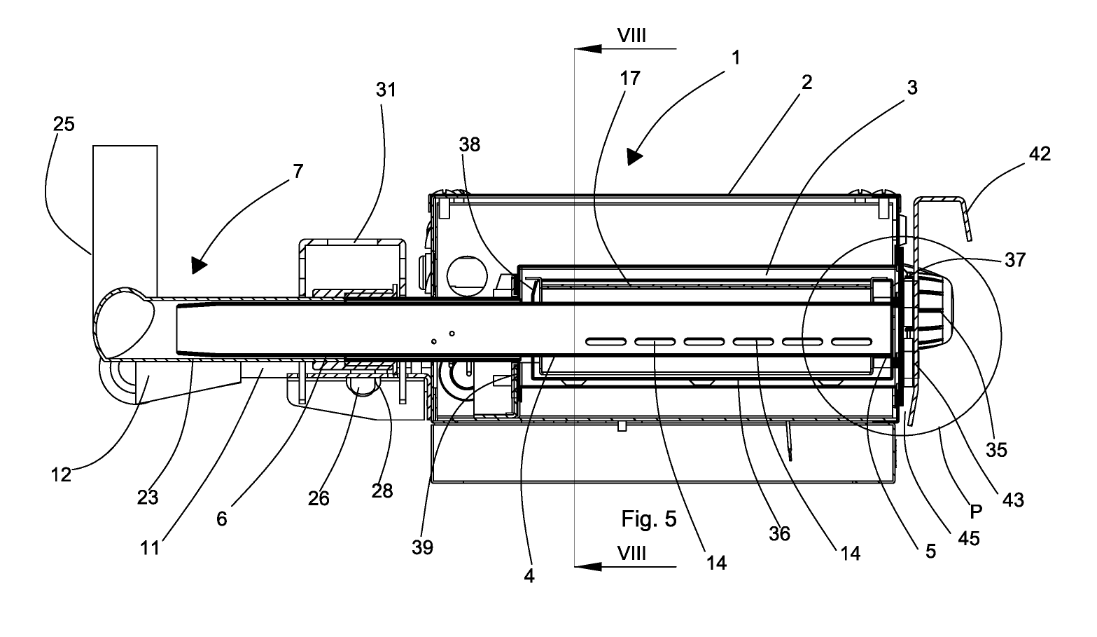

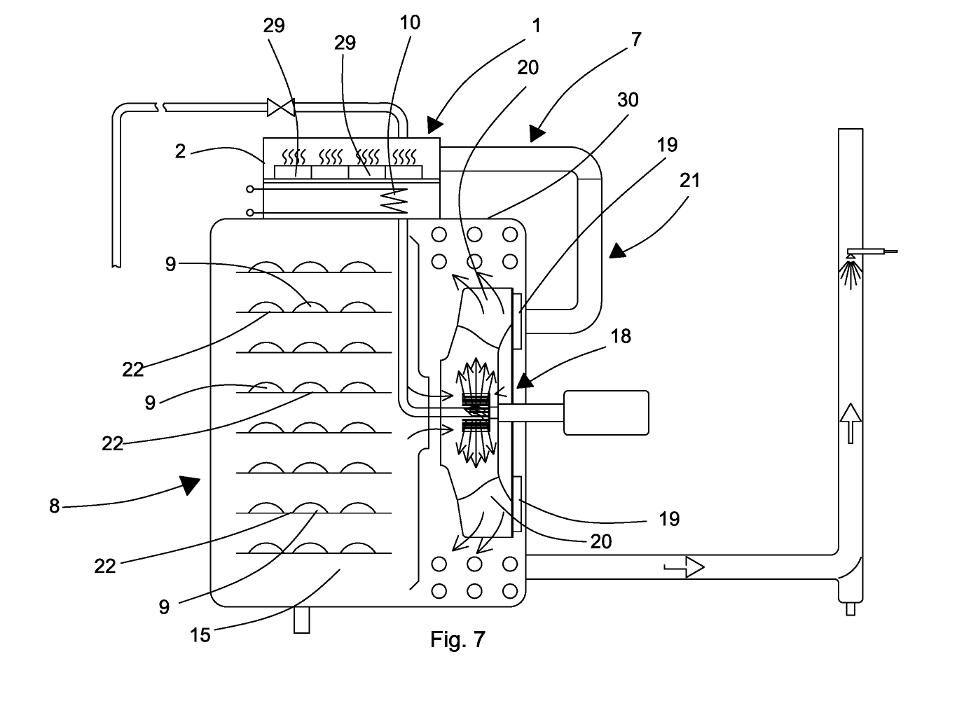

In the drawer 36, in a substantially central position, a tubular element is arranged 4 (FIG. 4), a first end 5 of which is fixed to the first wall 37 of the drawer 36. A second end 6 of the tubular element 4 passes through a second wall 38 of the drawer 36, opposite said first wall 37, through a bottom wall 39 of the chamber 3 and is inserted inside an outlet conduit 7, through which the smoke produced by combustion of the elements of combustible material can be sent to a cooking apparatus 8 (FIG. 7) to smoke foods 9 being cooked inside a cooking chamber 15 of the cooking apparatus 8. The cooking chamber 15 can be provided with planes 22 on which the foods 9 to be cooked and smoked can be arranged.

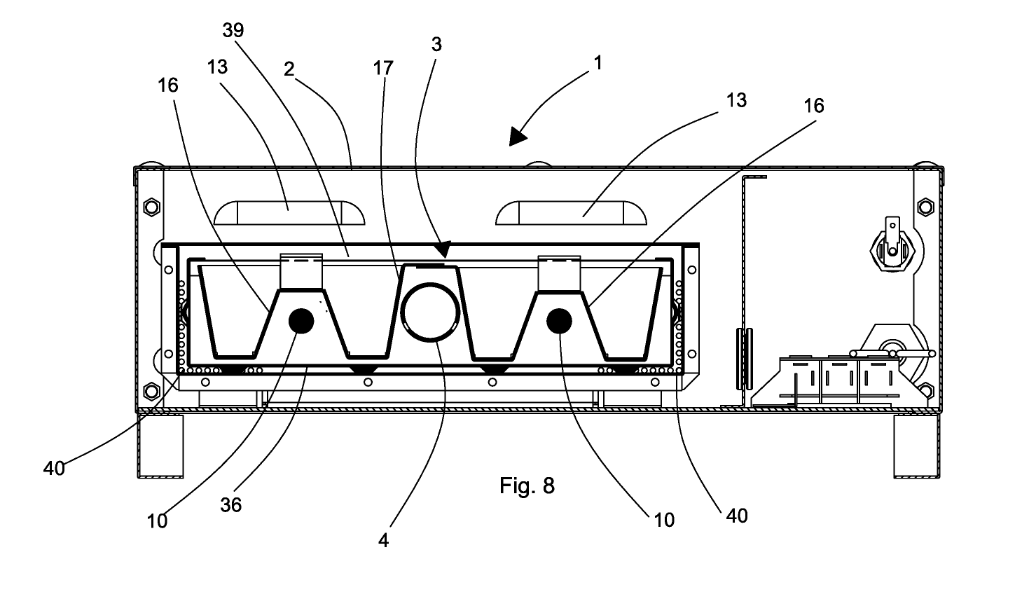

The bottom wall 39 of the chamber 3 can be provided with a plurality of further openings 40 (FIG. 8) through which the air can be delivered to the chamber 3 and to the drawer 36 to supply the oxygen necessary for the combustion of the elements of combustible material 29, as will be explained in greater detail below.

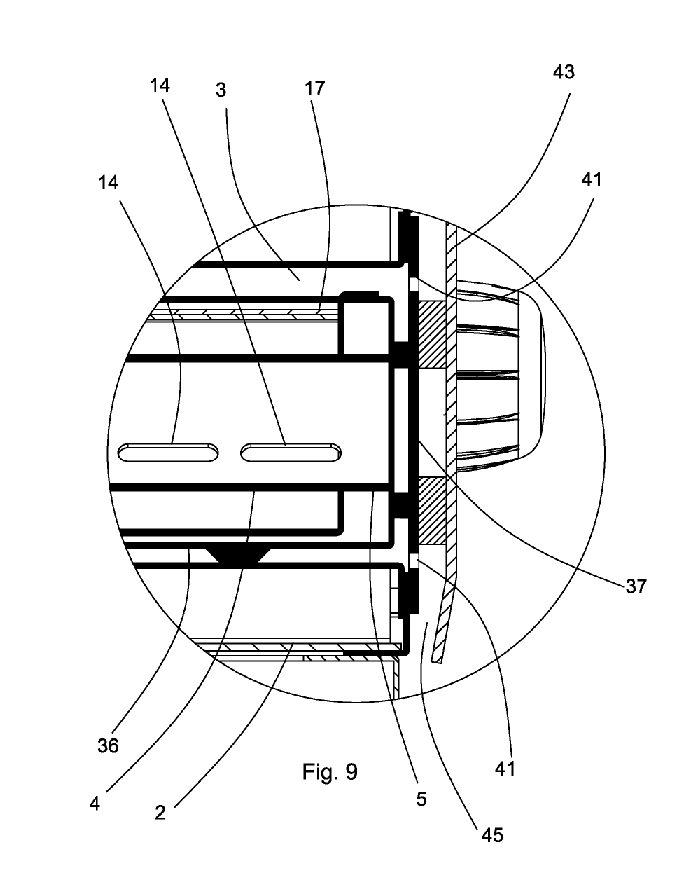

In one embodiment of the present invention, illustrated in FIG. 9, the bottom wall 39 of the chamber 3 is devoid of openings and the first wall 37 of the drawer 36 is provided with a plurality of still further openings 41 through which the air necessary for the combustion of the elements of combustible material 29 can be delivered into the drawer 36.

The tubular element 4 is provided with second suction openings 14, for example in the form of slots, communicating with the inside of the drawer 36, through which air and smoke produced by combustion of the elements of combustible material can be sucked inside the tubular element 4 and sent to the outlet conduit 7 and to the cooking chamber 15 of the cooking apparatus 8.

Advantageously, the second openings 14 can be distributed in a substantially uniform manner in a direction parallel to a longitudinal axis A of the tubular element 4.

Inside the chamber 3, at least one electrical resistance 10 is arranged that is used to heat the elements of combustible material 29 to a temperature that is sufficient to cause flameless combustion thereof that causes smoke to be produced to smoke the foods 9.

The at least one electrical resistance 10 can be powered by a power cable 11 that can be connected, by a plug 12, to a source of electric power.

In the illustrated embodiment, the smoking apparatus 1 is provided with two electrical resistances 10. Nevertheless, the number of electrical resistances 10 can be different from two without thereby falling outside the scope of the present invention. For example, the number and arrangement of the electrical resistances 10 inside the chamber 3 can be chosen on the basis of the shape and dimensions of the chamber 3.

The electric power with which the electrical resistances 10 are supplied can be adjusted by an adjusting element 34, for example a rheostat, which is drivable by a knob 35.

Each electrical resistance 10 is provided with a screening element 16, for example a net element, the function of which is to avoid direct contact of the respective electrical resistance 10 with the elements of combustible material, to prevent the elements of combustible material being subjected to rapid combustion with a fierce flame, which would reduce the smoke production and thus the efficiency of the smoking apparatus.

The tubular element 4 is provided with a protection element 17 that is arranged so as to prevent particles of combustible material being sucked inside the tubular element 4 and reaching the cooking chamber 15, contaminating the foods 9 contained therein. The protection element 17 is provided with further openings for the transit of air and smoke sucked by the chamber 3 through the second suction openings 14 of the tubular element 4. Advantageously, the protection element 17 can be a net element, but can also consist, for example, of a perforated metal sheet.

In order to send the smoke produced by the combustion of the elements of combustible material 29 to the cooking chamber 15 of the cooking apparatus 8, the outlet conduit 7 can be connected to the cooking apparatus 8 at a suction section 19 of a fan 18 of the cooking apparatus 8, the delivery section 20 of which communicates with the cooking chamber 15. A connecting conduit 21 can also be provided that leads into the cooking apparatus 8 at said suction section 19 and to which the outlet conduit 7 can be connected.

Advantageously, the outlet conduit 7 is made so as to be able to be removably connected to the cooking apparatus 8, or to the connecting conduit 21.

This enables the speed of the connection of the smoking apparatus 1 according to the invention to the cooking apparatus 8, or to the connecting conduit 21 and of the disconnection from the cooking apparatus 8, or from the connecting conduit 21 to be maximized.

Driving the fan 18 creates a vacuum in the connecting conduit 21, in the outlet conduit 7, in the tubular element 4, in the drawer 36 and in the chamber 3. This vacuum sucks air into the chamber 3 and into the drawer 36, through the first ventilation openings 13 and the further openings 40 made in the bottom wall 39 of the chamber 3, and sucking air and smoke, produced by the combustion of the elements of combustible material 29, in the tubular element 4, through the second suction openings 14, in the outlet conduit 7 and in the connecting conduit 21. The sucked air and smoke reach the suction section 19 of the fan 18 and are sent to the delivery section 20, by which the air and smoke sucked from the chamber 3 are pushed into the cooking chamber 15 of the cooking apparatus 8, to smoke the foods 9 contained therein.

In the case of the variant of the invention illustrated in FIG. 9, when the fan 18 is driven a vacuum is created in the connecting conduit 21, in the outlet conduit 7, in the tubular element 4, in the drawer 36 and in the chamber 3. This vacuum sucks air into the chamber 3 and into the drawer 36, through the space 45 and the still further openings 41 made in the first wall 37 of the drawer 36 and sucks air and smoke, produced by the combustion of the elements of combustible material 29, in the tubular element 4, through the second suction openings 14, in the outlet conduit 7 and in the connecting conduit 21. The sucked air and smoke reach the suction section 19 of the fan 18 and are sent to the delivery section 20, by which the air and smoke sucked from the chamber 3 are pushed into the cooking chamber 15 of the cooking apparatus 8, to smoke the foods 9 contained therein.

It should be noted that the shape, dimensions and distribution of the further openings 40 or of the still further openings 41 are chosen so as to ensure sucking of a flowrate of air sufficient to ensure flameless combustion of the elements of combustible material 29, but not permit combustion with flames, which would cause a significant reduction in the production of smoke and thus a significant decrease in the efficiency of the smoking device 1 according to the invention.

The smoking apparatus 1 according to the invention can be arranged in any position with respect to the cooking apparatus 8, for example can be arranged on the upper part 30 of the cooking apparatus 8, as illustrated in FIG. 6.

In order to facilitate and make flexible the positioning of the smoking apparatus 1 according to the invention with respect to the cooking apparatus 8, the outlet conduit 7 can be provided with two or more portions that are perpendicular to one another, for example at least one first portion 23 that is coaxial with the tubular element 4 and a second portion 24 that is perpendicular to the first portion 23. Also further portions 25 can be provided that are perpendicular to one another and perpendicular to the second portion 24. It is also possible to provide for the corners between a portion of outlet conduit 7 and the portions adjacent thereto being other than 90°, and different from one another, depending on the positioning of the smoking apparatus 1 with respect to the cooking apparatus 8. Further, the portions 23, 24, 25 of the outlet conduit 7 can have a rectilinear or curvilinear axis.

It is further advantageous for the portions of the outlet conduit 7 to be able to be removably connected together so as to be able to add or remove portions to the outlet conduit 7, on the basis of the requirements for connection to the cooking apparatus 8.

Advantageously, the first portion 23 of the outlet conduit 7 is inserted into the second end 6 of the tubular element 4, which is concentric to said second end 6, so as to be able to rotate around the longitudinal axis A of the tubular element 4. This arrangement enables the outlet conduit 7 to be oriented in the best way to make the connection to the cooking apparatus 8 easier.

The first portion 23 of the outlet conduit 7 is supported by a supporting element 31, so as to be able to rotate with respect thereto, said supporting element 31 being fixed to said body 2.

The first portion 23 of the outlet conduit 7 is provided with a pin 26 that protrudes radially from the first portion 23 and which is arranged for coupling with a first seat 27 and with a second seat 28 obtained on opposite sides on the support 31. Coupling of the pin 26 with the first seat 27 or with the second seat 28 defines the stroke end positions of the rotation of the outlet conduit 7.

The outlet conduit 7 can be connected to a maneuvering rod 32 provided with a grip 33, by which the outlet conduit 7 can be rotated.

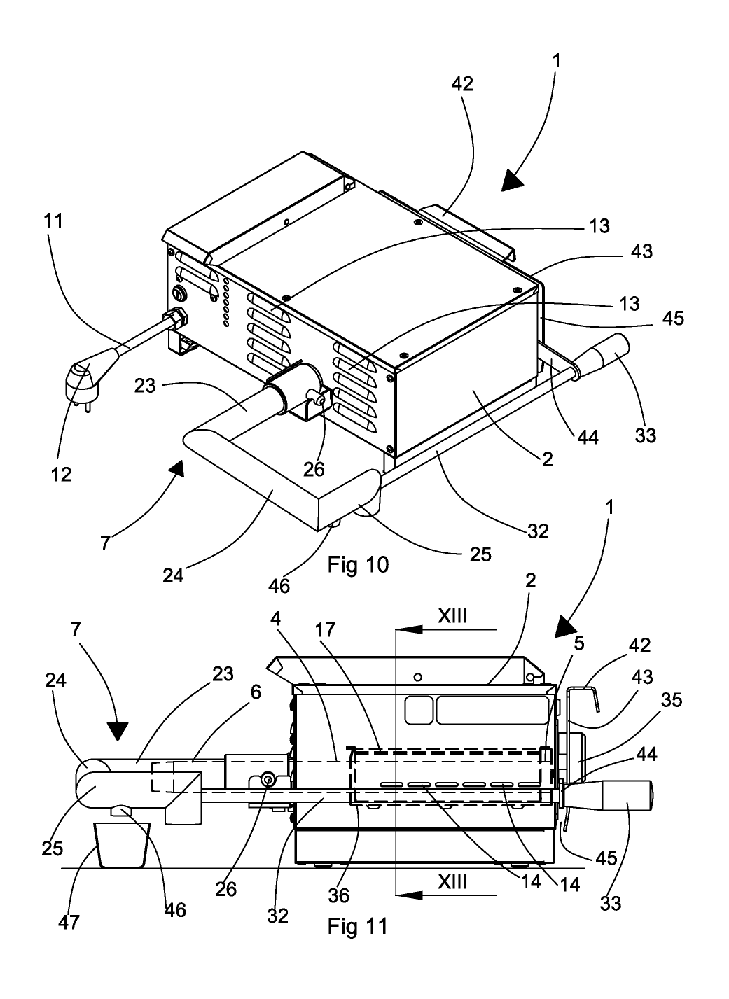

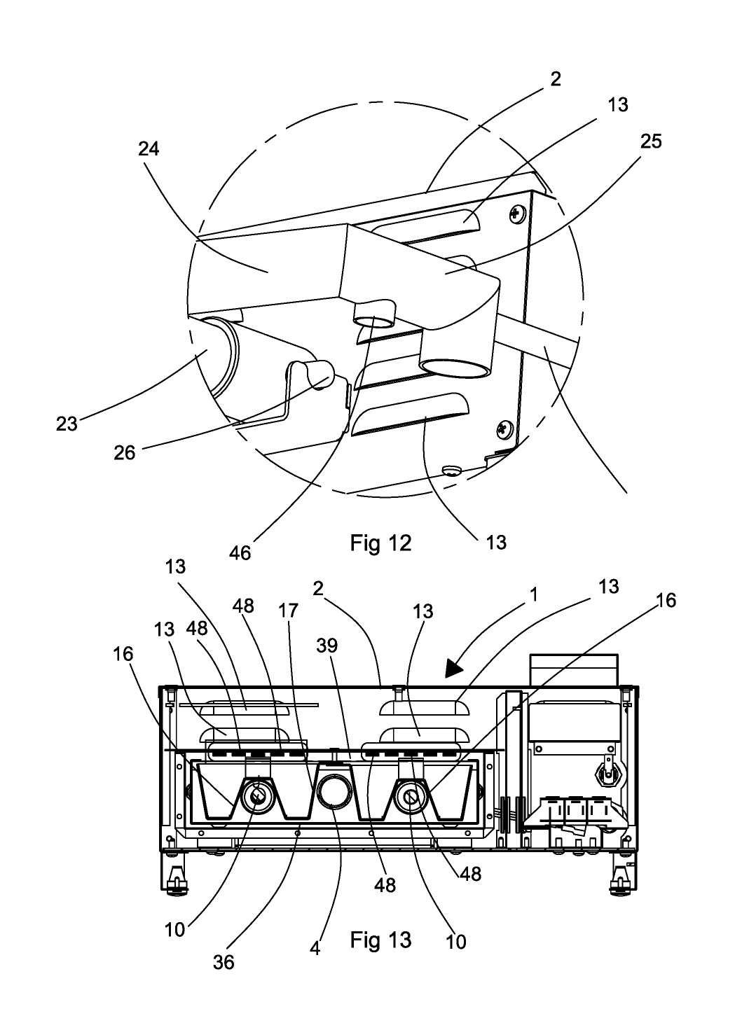

In FIGS. 10 to 13 a variant on the smoking apparatus 1 according to the invention is illustrated.

In this variant, the smoking apparatus is provided with a locking element 44 configured so as to lock the drawer 36, to prevent opening thereof during operation of the smoking apparatus, to prevent smoke and high-temperature elements 29 present in the drawer 36 escaping into the environment.

The locking element 44 can consist of a plate fixed in a cantilevered manner to the maneuvering rod 32 and extending perpendicularly to the maneuvering rod 32, said plate being configured so as to be able to be inserted into the space 45.

By rotating the maneuvering rod 32 to the position illustrated in FIGS. 10 and 11, the plate 44 is inserted into the space 45, preventing the drawer 36 from opening.

The smoking apparatus 1 illustrated in FIGS. 10 to 13 is further provided with a condensate discharge 46 made in the further portion 25 of the outlet conduit 7. The condensate discharge can be made by making a hole in the wall of the further portion 25 and connecting a short tubular element to said hole.

The condensate discharge is used to discharge to the outside of the smoking apparatus 1 possible condensate that forms from the smoke produced during operation of the smoking apparatus 1, to prevent said condensate reaching the inside of the oven.

The condensate discharged through the discharge 46 can be collected in a receptacle 47 placed below the discharge 46.

In the smoking apparatus 1 illustrated in FIGS. 10 to 13 the further openings made in the bottom wall 39 of the chamber 3 have the shape of slits 48, arranged on one or more rows along the bottom wall 39. The dimensions, the number and the distribution of the slits 48 are so chosen as to ensure sucking of a flowrate of air that is sufficient to permit flameless combustion of the elements of combustible material 29, but not permit combustion with flames.

The locking element 44, the discharge 46 and the slits 48 can be present singularly or in combination between themselves in a smoking apparatus 1 according to the invention.

1. A smoking apparatus that comprises a body inside which a chamber is defined into which a slidable element is insertable in which elements of combustible material can be arranged, a heating arrangement that is arranged in said slidable element to heat said elements of combustible material and cause flameless combustion thereof with generation of smoke, wherein in said slidable element a tubular element is arranged that is provided with a plurality of second suction openings communicating with the inside of said slidable element, said tubular element being connected, at a first end, to a first wall of the slidable element, whereas a second end thereof is inserted into an outlet conduit.

2. The smoking apparatus according to claim 1, wherein a locking element is provided that is configured so as to lock said sliding element.

3. The smoking apparatus according to claim 1, wherein said second suction openings are distributed substantially uniformly in a direction parallel to a longitudinal axis of the tubular element.

4. The smoking apparatus according to claim 1, wherein said tubular element is provided with a protection element provided with further openings.

5. The smoking apparatus according to claim 4, wherein said protection element includes a net or a perforated metal sheet.

6. The smoking apparatus according to claim 1, wherein said heating arrangement includes an electrical resistance, or a plurality of electrical resistances.

7. The smoking apparatus according to claim 6, wherein said electrical resistance or each electrical resistance of said plurality of electrical resistances is provided with a screening element.

8. The smoking apparatus according to claim 1, wherein said outlet conduit can be removably connected to a cooking apparatus for cooking foodstuffs such as to send said smoke generated in said chamber to a cooking chamber of said cooking apparatus in which said foodstuffs are arranged, said outlet conduit being able to be connected to said cooking apparatus directly or by a connecting conduit.

9. The smoking apparatus according to claim 1, wherein said outlet conduit includes a first portion and a second portion that forms a first angle with said first portion, said first portion being fitted concentrically on said second end.

10. The smoking apparatus according to claim 9, wherein said outlet conduit includes at least one further portion that forms a second angle with said second portion.

11. The smoking apparatus according to claim 9, wherein said outlet conduit includes a plurality of further portions that form further angles between themselves and with said second portion.

12. The smoking apparatus according to claim 9, wherein said first portion, said second portion and said at least one further portion can have a rectilinear or curvilinear axis.

13. The smoking apparatus according to claim 9, wherein said first portion, said second portion and said at least one further portion are made in such a manner as to be removably connected together.

14. The smoking apparatus according to claim 3, wherein said outlet conduit is rotatable around said longitudinal axis.

15. The smoking apparatus according to claim 14, wherein said first portion of the outlet conduit is supported by a supporting element so as to be able to rotate with respect thereto, said supporting element being fixed to said body.

16. The smoking apparatus according to claim 14, wherein the first portion of the outlet conduit is provided with a pin that protrudes radially from said first portion and which is arranged for coupling with a first seat and with a second seat obtained on opposite sides on said support.

17. The smoking apparatus according to claim 14, wherein said outlet conduit can be connected to a maneuvering rod provided with a grip, by which the outlet conduit can be rotated.

18. The smoking apparatus according to claim 17, wherein said locking element includes a plate fixed in a cantilevered manner to the maneuvering rod and extending perpendicularly to the maneuvering rod, said plate being configured so as to be able to be inserted into a space defined between said first wall and a plate connected to said first wall.

19. The smoking apparatus according to claim 1, wherein said body includes at least one first ventilation opening through which air from the outer environment can be sucked inside said body, a bottom wall of said chamber being provided with a plurality of further openings, the number, the shape, the dimensions and the distribution of said openings being chosen so as to ensure sucking of a flowrate of air that is sufficient to permit flameless combustion of the elements of combustible material, but not permit combustion with flames.

20. The smoking apparatus according to claim 1, wherein said body includes at least one first ventilation opening through which air from the outer environment can be sucked inside said body and said first wall of said sliding element is provided with a plurality of still further openings, the number, the shape, the dimensions and the distribution of said still further openings being chosen so as to ensure sucking of a flowrate of air sufficient to ensure flameless combustion of the elements of combustible material, but not permit combustion with flames.
